(19) United States
(12) Patent Application Publication
(10) Pub. No.: US 2005/0021426 A1
(43) Pub. Date: Jan. 27, 2005

(54) Invoice tracking

(76) Inventors: Fabien Leroux, Grenoble (FR); Dominique Jamet, Voreppe (FR); Jean-Luc Valfort, Claix (FR); Claire Haese, Grenoble (FR)

Correspondence Address: HEWLETT-PACKARD COMPANY;Intellectual Property Administration, P.O. Box 272400, Fort Collins, CO, 80527-2400, US

(21) Appl. No.: 10/738,663

(22) Filed: Dec. 16, 2003

(30) Foreign Application Priority Data
Jul. 25, 2003 (EP) 03 291 853.4

(51) Int. Cl. G06F 17/60

(52) U.S. Cl. 705/29

(57) ABSTRACT

In a method of enabling an invoice issuer to track, via a Web interface, a processing status of invoices, the invoice issuer is enabled to upload an invoice list with list items referring to invoices issued to an invoice recipient. The list items are correlated with invoices received from the invoice issuer. Invoice-status data including information identifying invoices referred to in the invoice list and information about their current processing status into the Web interface. The invoice-status data are accessible by the invoice issuer via the Web interface.

### FIELD OF THE INVENTION

The present invention relates to invoice tracking, and, for example, to a method, a server computer system and a computer program product for enabling an invoice issuer to track the processing status of invoices via a Web interface, as well as such a Web interface and an assembly of Web pages representing such an interface.

### BACKGROUND OF THE INVENTION

An invoice payment process goes through different phases, as a result of which different status may be assigned to an invoice. Typically, when an invoice is received by an invoice recipient, an “open status” is assigned to the invoice. Then, it is verified that the invoice is correct. If the outcome of the verification is positive, payment of the invoice is approved, i.e. an “approved status” is assigned to it. Finally, the invoice is paid, and a “paid status” is assigned to it. For more than two decades invoice payment processes of this kind have been carried out using computers programmed with suitable invoice processing applications.

Typically, the invoice payment process has been carried out by the invoice recipients in a way that was invisible for the invoice issuer. The only activity the invoice issuer would observe after having submitted an invoice was the receipt of the invoiced amount. When an invoice was not paid, the invoice issuer typically sent a letter demanding payment to the invoice recipient.

There have been attempts to introduce electronic invoice interchange systems in which all invoice issuers and recipients are linked by a suitable Electronic Data Interchange (EDI) system, and all invoices are electronically submitted in a pre-defined EDI format. In a known electronic invoice interchange system, as described in U.S. Pat. No. 6,507,826 B1, the invoice issuer is not only able to transmit his invoices in electronic form to the invoice recipient via the Internet, but also to obtain status information about the issued invoices from the invoice recipients via the Internet (see, for example, FIG. 4 of U.S. Pat. No. 6,507,826 B1). However, such electronic invoice interchange systems have not been generally accepted, presumably since they require a close integration between the invoice issuer's and recipient's accounting computer systems, which may cause high implementation and support costs.

### SUMMARY OF THE INVENTION

The invention is directed to a method of enabling an invoice issuer to track, via a Web interface, the processing status of invoices issued to and processed by an invoice recipient. The method comprises: enabling the invoice issuer to upload an invoice list with list items referring to invoices issued to the invoice recipient; correlating the list items with invoices received from the invoice issuer; putting invoice-status data including information identifying invoices referred to in the invoice list and information about their current processing status into the Web interface. The invoice-status data are accessible by the invoice issuer via the Web interface.

According to another aspect, a computer system is provided that is arranged to provide a Web interface enabling an invoice issuer to track the processing status of invoices issued to and processed by an invoice recipient. The Web interface is arranged to enable the invoice issuer to upload an invoice list with list items referring to invoices issued to the invoice recipient. The computer system is arranged to correlate the list items with invoices received from the invoice issuer and to put invoice-status data including information putting invoice-status data including information identifying invoices referred to in the invoice list and information about their current processing status into the Web interface. The Web interface is arranged to grant the invoice issuer access to invoice-status data upon request.

According to another aspect, a computer system is provided for enabling an invoice issuer to track the processing status of invoices issued to and processed by an invoice recipient a Web interface. It comprises: a data base arranged to store invoice-related data; an invoice-list-upload component; an invoice-correlation component; a Web-page-preparation component arranged to include stored invoice-related data in Web pages; and a Web-page-forward component.

According to another aspect, a computer program product is provided including program code, when executed on a computer system, for providing a Web interface enabling an invoice issuer to track the processing status of invoices issued to and processed by an invoice recipient. The program code is arranged to: enable the invoice issuer to upload an invoice list with list items referring to invoices issued to the invoice recipient; correlate the list items with invoices received from the invoice issuer; put invoice-status data including information identifying invoices referred to in the invoice list and information about their current processing status into the Web interface; and grant the invoice issuer access to invoice-status data upon request.

According to another aspect, a Web interface is provided for enabling an invoice issuer to track the processing status of invoices issued to and processed by an invoice recipient. The Web interface is arranged to enable the invoice issuer to upload an invoice list with list items referring to invoices issued to the invoice recipient, present invoice-status data including information identifying invoices referred to in the invoice list and information about their current processing status; and grant the invoice issuer access to invoice-status data upon request.

According to another aspect, an assembly of Web pages is provided representing a Web interface for enabling an invoice issuer to track the processing status of invoices issued to and processed by an invoice recipient. The Web pages are arranged such that the invoice issuer is able to upload an invoice list with list items referring to invoices issued to the invoice recipient; and that invoice-status data are presented to the invoice issuer upon request. The invoice-status data include information identifying invoices referred to in the invoice list and information about their current processing status.

Other features are inherent in the methods and products disclosed or will become apparent to those skilled in the art from the following detailed description of embodiments and its accompanying drawings.

### DESCRIPTION OF THE DRAWINGS

Embodiments of the invention will now be described, by way of example, and with reference to the accompanying drawings, in which:

FIG. 1 is a flow chart of a method of processing invoices and enabling an invoice issuer to track the invoice-processing status;

FIG. 2 is a scheme illustrating the multi-communication ability of the Web interface of FIG. 1;

FIG. 3 illustrates an assembly of Web pages representing a Web interface with the functionality shown in FIGS. 1 and 2;

FIG. 4 shows an exemplary upload page;

FIG. 5 shows an exemplary invoice-status-list page;

FIG. 6 shows exemplary forum and message pages;

FIG. 7 shows a high-level functional architecture diagram of a server computer system.

### DESCRIPTION OF EMBODIMENTS

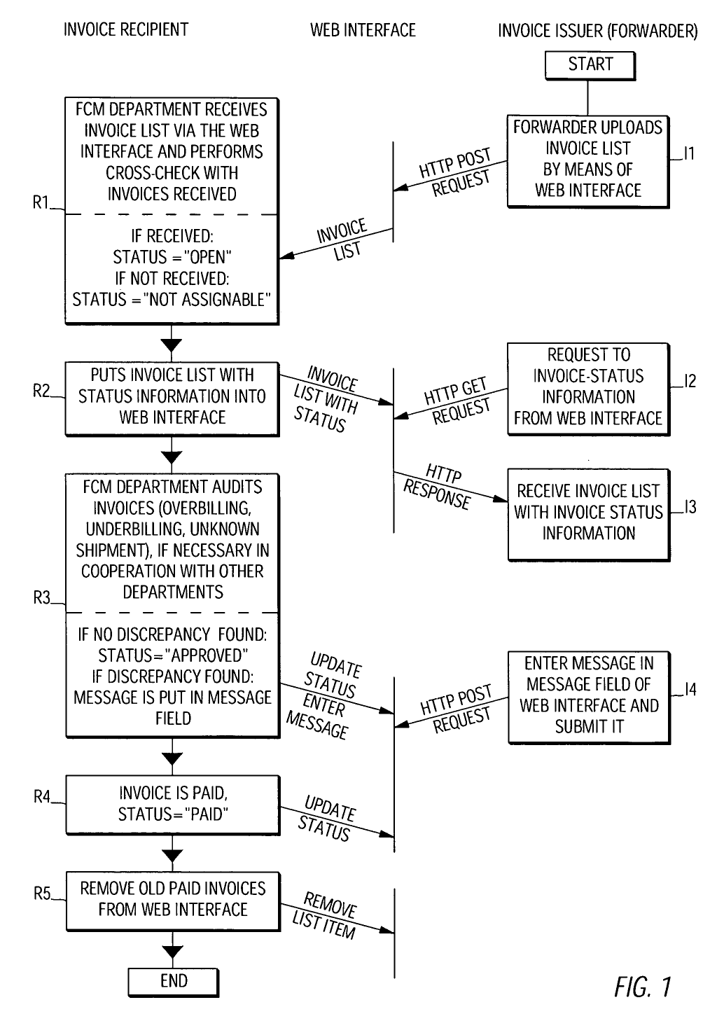

FIG. 1 illustrates, by means of a flow chart, a method of processing invoices and enabling an invoice issuer to track the invoice-processing status. Before proceeding further with the description of FIG. 1, however, a few items of the embodiments will be discussed.

The embodiments enable an invoice issuer to track the processing status of invoices issued to and processed by an invoice recipient via a Web interface. The invoice issuer uploads an invoice list with list items referring to invoices issued to the invoice recipient. For example, the invoice list may be in the form of a spreadsheet (e.g. an Excel sheet), wherein each line of the spread sheet corresponds to a single debit note. Alternatively, the invoice list may be represented by an XML document. The format of the invoice list, in particular the number and meaning of the list attributes (including a requirement whether a certain attribute is mandatory or optional) is, for example, predetermined by the invoice recipient (it might also be a generally accepted standard format). Normally, an invoice issuer will combine information about a number of invoices (for example, all the invoices issued during one week), in one invoice list, so as to keep the number of upload operations small. Of course, the term “invoice list with list items” also includes the particular case of an invoice list with only one list item, since it may happen that only one invoice was issued in the time period between uploads. In some of the embodiments, the upload is performed by a file transfer, independent of the interface. In other embodiments the Web interface provides an upload by means of a HTTP POST request.

In contrast to the technology proposed in U.S. Pat. No. 6,507,826 B1, the invoice list is not an aggregation of invoice information prepared by the invoice recipient of the invoices received by him, but it is rather an additional and independent source of invoice information prepared and provided by the invoice issuer. This enables a consistency check to be made by correlating the invoice-list items with the invoices received from the invoice issuer. This check has three possible outcomes: (i) the invoices quoted in the invoice list match the invoices actually received; (ii) one or more of the invoices mentioned in the invoice list cannot be assigned to an invoice received; (iii) there are one or more received invoices without a counterpart in the invoice list (of course, there may be a combination of cases (ii) and (iii)). The concept of providing an additional and independent invoice list is not limited to a particular way of submitting the actual invoices to the recipient; for example, it works irrespective of whether the invoices are submitted as paper documents, electronic unstructured documents (such as PDF files) or structured electronic documents (such as spreadsheets or XML documents).

Invoice-status data including information identifying invoices mentioned in the invoice list and, in addition, information about the current processing status of the invoices are then put into the Web interface by the invoice recipient. In some of the embodiments, the invoice-status data are in a form similar to the original invoice list, extended by one or more status attributes (a status attribute field may even already be included in the original uploaded invoice list, and the status attribute may be left blank). The invoice-status data reflect the current status of the individual invoices. As the processing of invoices proceeds at the recipient's side (e.g. as a background process), the status of the invoices may, for example, change from “open” to “approved” and, finally, to “paid”, and the invoice-status data in the Web interface is updated in the course of this process to reflect the current invoice status.

In some of the embodiments the activity of correlating the list items with received invoices is performed before the invoice-status data is put into the Web interface. If an invoice quoted in the invoice list cannot be assigned to an invoice received, the corresponding list item may obtain a corresponding status, such as “not assignable”. In other embodiments, an invoice-status list is put into the Web interface before the activity of correlating the list items with invoices received is performed. Of course, the status attribute is then left free, since status information is not available at this initial stage, it only becomes available when the activity of correlating is performed at a later stage. The definition “correlating the list items” and “putting invoice-status data into the Web interface” is meant to cover at least both of these embodiments.

In the embodiments, the invoice-status data are accessible by the invoice issuer via the Web interface. Typically, the invoice issuer will only have read-access to the invoice-status list; e.g. he will receive a HTML page including the invoice-status list upon a corresponding request to the invoice recipient, but he will not be permitted to modify the invoice-status data, e.g. by a POST command, or the like. In some of the embodiments, the invoice issuer is asked to identify or authenticate himself before invoice-status data are made accessible to him, in order to ensure that he cannot access private data of the invoice recipient or data of other invoice issuers. By granting the invoice issuer such a read-access to the invoice-status data, he is able to verify that the invoices have been received by the invoice recipient and to track the invoice's processing status, without the need to consult the invoice recipient.

In some of the embodiments, the Web interface is also arranged to serve as a “forum” or “chat room” for the parties involved, e.g. the invoice issuer and different departments of the recipient. To this end, the Web interface has a message field into which messages, for example in the form of text, can be input. This “message information” may be generally related to a certain invoice issuer; it may further be associated with individual list items (e.g. invoices) of the invoice list. In some of the embodiments the invoice issuer has only read-access to this message information in the Web interface. For example, when an invoice is quoted in an uploaded invoice list, but none of the invoices received can be assigned to it, the invoice recipient may put a message into the Web interface indicating this problem. The invoice issuer can read this message, and act accordingly (e.g. submit a copy of the missing invoice). In other embodiments, the invoice issuer has write-access to the “forum”, e.g. the same or a different message field in the Web interface. In the example above, he might then enter an explanation of when and where the missing invoice was submitted, or the like.

In some of the embodiments, the Web interface is not only used for invoice-related information transfer between the invoice issuer and recipient, but also between different departments of the invoice recipient. For example, in the approval process, a department responsible for the approval of invoices may need assistance from another department which was responsible for negotiating the contract between the invoice issuer and recipient on the basis of which the invoice issuer rendered the invoiced services. To this end, the “forum” functionality of the Web interface may be used. For example, the approval department may put corresponding message information (e.g. an inquiry) into a message field of the Web interface, and the other department responsible for contract negotiation may respond to the inquiry by putting message information (e.g. the response to the inquiry) into the Web interface's message field.

The different participants may have different access rights to the Web interface. For example, an invoice issuer may have read-access to invoice-status data and message information pertaining to him (but not to other invoice issuers), and also write-access to message information. A certain department of the invoice recipient may have read-access to invoice-status data and message information pertaining to all invoice issuers, and write-access to message information. Another department of the invoice recipient may have unlimited read and write-access to all invoice-status data and message information. In other embodiments, several departments may even be authorized to change the status information included in the invoice-status data of the Web interface.

An exemplary field in which the embodiments are used is the field of forwarding services and freight cost management. In this example, the invoice issuer is a forwarder, and the invoice recipient's department mainly responsible for the communication with the forwarder via the Web interface and for the approval of invoices is a freight cost management department.

A Web interface can be considered as an assembly of Web pages representing the interface, which are sent by a server computer system to a client as a response to the client's request, together with an interface functionality inherent in these pages. The “client” may be a host computer of the invoice issuer or of different departments of the invoice recipient, as explained above. The Web interface of the embodiments provides a functionality as follows: it enables the client to identify or authenticate himself and provides only that subset of Web pages and that type of access (read-access or read/write-access) to which the respective client is authorized; it provides one or more Web pages which enable the client to upload an invoice list; it provides one or more Web pages which present invoice-status data; and it updates the invoice-status data presented so that they always reflect the invoice recipient's current processing status of the invoices. In view of the above-mentioned identification or authentification requirement, all these transactions and, optionally, further requests and responses between the client and the server are preferably linked together to a session, for example based on a session identifier technique, and in some embodiments, a secure session, for example based on SSL (Secure Sockets Layer) is established. The protocol used may then be HTTPS, i.e. HTTP over SSL.

From the client's perspective, the Web interface is represented by the assembly of the above-mentioned Web pages (wherein the accessible assembly may be a subset of the full assembly of Web pages, depending on the type of client, as explained above). The client can load these Web pages via the Internet or an intranet (i.e. the world-wide internet or an intranet using the TCP/IP protocol suite) with the HTTP request-response protocol. The source code of the Web pages is commonly written in the HyperText Markup Language (HTML) or any other suitable language which may be processed by Web browsers, such as the Extensible Markup Language (XML). The Web pages may include mobile code, such as scripts (e.g. JavaScript) and/or compiled program inserts (such as Java Applets). The mobile code can provide for a dynamic appearance of the Web pages at the client's browser. The invoice-status data and message information are preferably not stored at the client's host, but at the server's site. The upload of invoice lists and message information is preferably effected by HTTP POST requests sent from the client to the server, by using an upload page or a message page previously loaded from the server.

The embodiments of the computer program product with program code for performing the described methods include any machine-readable medium that is capable of storing or encoding the program code. The term “machine-readable medium” shall accordingly be taken to include, but not to be limited to, solid state memories, optical and magnetic storage media, and carrier wave signals. The program code may be machine code or another code which can be converted into machine code by compilation and/or interpretation such as source code in a high-level programming language, e.g. Java and ASP (Active Server Pages).

The disclosed embodiments also include a server computer system for providing the Web interface. The server computer system comprises a database arranged to store invoice-related data, an invoice-list-upload component, an invoice-correlation component, a Web-page-preparation component arranged to include stored invoice-related data in Web pages, and a Web-page-forward component. The invoice-list-upload component is arranged to receive invoice lists uploaded by invoice issuers and to store the information contained in them in the database. The invoice-correlation component is arranged to correlate the list items of the invoice list with invoices received from the invoice issuer. The Web-page-preparation component is arranged to prepare Web pages which include invoice-status information, e.g. stored in the database. The Web-page-forward component is arranged to forward prepared Web pages to a client, e.g. to an invoice issuer, on request. Further components, such as an identification and authentication component and a session-establishment component may be provided.

It should be noted that this subdivision in several components is functional and does not necessarily imply a corresponding structural division. The functional components can, of course, be merged with other functional components or can be made of several distinct functional sub-components.

Returning now to FIG. 1, it illustrates, by means of a flow chart, a method of processing invoices and enabling an invoice issuer to track the invoice-processing status. At I1, an invoice issuer (who, for example, may be a forwarder) uploads an invoice list by means of a Web interface to an invoice recipient, for example to a company the invoice issuer provided with forwarding services. The invoice list may be uploaded line by line, or by a “mass upload”, e.g. in the form of an Excel file. Uploading the invoice list does not mean “filing the invoices”; rather, the invoice items in the invoice list refer to invoices that have already been sent or are to be sent to the invoice recipient via other channels, e.g. as paper documents or (unstructured or structured) electronic documents. The invoice items in the invoice list typically contain header information of the invoices to which they refer, for example, the invoice number, invoice date, the amount of the invoice, etc.

At R1, a department of the invoice recipient which is responsible for the invoice processing (here a freight cost management (FCM) department) receives the invoice list via the Web interface, and performs a cross-check of the invoices quoted in it with the invoices received by the invoice recipient through the other channel. If it is found that a quoted invoice has been received, its status is set to “open”. If, however, for a particular quoted invoice, no corresponding received invoice can be found, its status is set to “not assignable”. At R2, the invoice list, amended by the status information determined at R1, is put into the Web interface.

The invoice issuer (as well as other departments of the invoice recipient) may send a request for invoice status information to the Web interface, as shown at I2 in FIG. 1. The request may be an HTTP GET request which may be generated by clicking on a request button in a Web-page of the Web interface. The server computer hosting the Web interface returns an HTTP response with the invoice list including the invoice-status information.

The invoice processing is continued as a background task. At R3, the FCM department audits invoices with the “open” status. For example, it is verified that the billed service has actually been provided (e.g. that it does not refer to an “unknown shipment”) and that there is no overbilling or underbilling. If necessary, this auditing is performed in co-operation with the invoice recipient's other departments. This co-operation may be carried out by using the forum functionality of the Web interface, i.e. by putting an inquiry and a response to it into a message field of the Web interface. If the auditing reveals that the billing is correct, the status of the invoice is set to “approved”. However, if a discrepancy is found, a corresponding message is put in a message field of the Web interface associated with the invoice in question.

The status information presented by the Web interface is updated as soon as a status change occurs. The invoice issuer can request the status information at any time, for example at I2, and receives a corresponding response, including the above-mentioned messages as well as information about a discrepancy, where appropriate. The invoice issuer may input a message (for example a response message) in a message field of the Web interface, and may submit it, for example by clicking on a submit button (which may actually trigger an HTTP POST request), as indicated at I4.

Such messages deposited in the Web interface may be used when the auditing is resumed; for example, it may result in “approved” status being assigned to an invoice that had previously been called in question.

At R4, the invoice is paid, and the status is accordingly set to “paid”. After a certain period of time has elapsed, old paid invoices are removed from the invoice list presented in the Web interface at R5.

In FIG. 1, the activities R1, R2, R4 and R5 as well as the uploading and updating of data from and to the Web interface and also the forwarding of HTTP responses to HTTP requests are automatically carried out in computer-based processes, without the need for human interaction. However, although the auditing activity in R3 may be partly automated, there will generally be an interaction between an auditor (and, if necessary, the invoice recipient's other departments) and the computer-based process.

The HTTP requests and responses are preferably Secure HTTP (HTTPS) requests and responses, i.e. HTTP used over SSL.

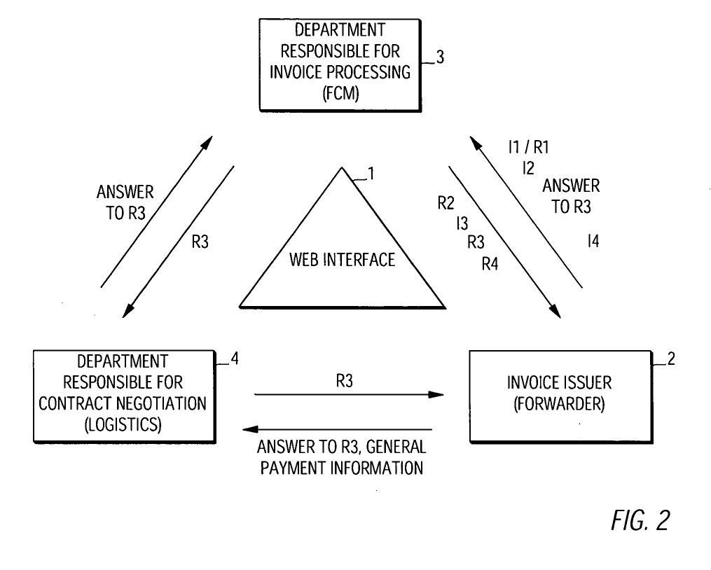

FIG. 2 is a scheme illustrating the multi-communication ability of the Web interface, denoted by “1” in FIG. 2. The Web interface 1 enables different participants of the invoice processing and payment process to access and submit invoice-related information. In the exemplary scheme of FIG. 2, three participants are shown, an invoice issuer 2, here a forwarder, and two of the invoice recipient's departments, here a department responsible for invoice processing 3 (FCM) and a department responsible for contract negotiation 4 (logistics). All participants 2, 3, 4 are able to directly submit and access invoice-related information via the Web interface 1; the participants 2, 3, 4, the communication between them and the Web interface 1 are therefore shown in a triangular arrangement in FIG. 2. Most of the information is exchanged between the invoice issuer 2 and the department responsible for invoice processing 3. For example, the information associated with the activities R1, I1, I2 and I4 as well as a possible answer to a message originating from R3 (FIG. 1) is transmitted from the invoice issuer 2 to the department responsible for invoice processing 3 via the Web interface 1. In turn, the information associated with the activities R2, R3, R4 and I3 (FIG. 1) is transmitted from the department responsible for invoice processing 3 to the invoice issuer 2 via the Web interface 1. In order to obtain information needed in the auditing process R3, information is exchanged between the department responsible for invoice processing 3 and the department responsible for contract negotiation 4, via the Web interface's invoice-status lists and message fields. Finally, there may also be a direct communication channel between the invoice issuer 2 and the department responsible for contract negotiation 4. For example, if a discrepancy is found in the auditing process R3 which cannot be resolved by the department responsible for contract negotiation 4, this department 4 may enter a message (e.g. an inquiry) destined for the invoice issuer 2 into a message field of the Web interface 1. The invoice issuer may enter a message answering the inquiry from the department responsible for contract negotiation 4, which, on the basis of this answer, may enter an answer to the original inquiry from the department responsible for invoice processing 3. Furthermore, the department responsible for contract negotiation 4 may take general payment information pertaining to a certain invoice issuer 2 from the invoice-status list of the Web interface 1 (e.g. information about the frequency of discrepancies); such information may be useful to negotiate future contract conditions with invoice issuers.

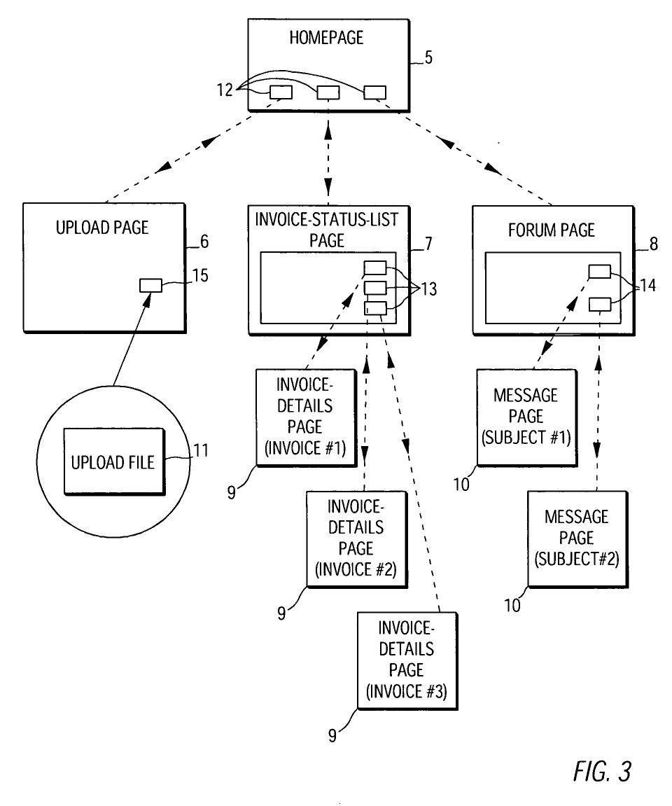

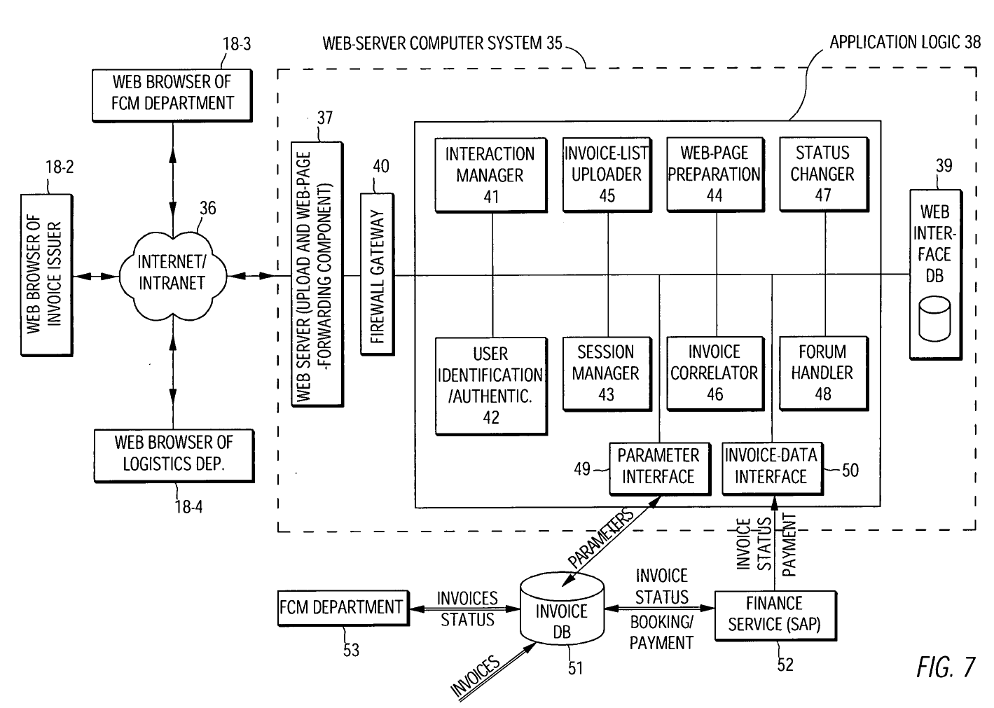

FIG. 3 illustrates the Web interface from the participant's perspective. The Web interface is an assembly of several related Web pages to which the Web interface functionality are inherent, as described above in conjunction with FIGS. 1 and 2 and below with FIG. 7. Commonly, the participant 2, 3, 4 will consecutively load the different Web pages into his Web browser, so that only one Web page is visible at a time from his perspective. Only for illustrative purposes, the different Web pages are shown side by side in FIG. 3. Hyperlinks between the Web pages are indicated with broken lines and arrows in FIG. 3. The participant may start at a home page 5 which comprises hyperlinks 13 to an upload page 6, an invoice-status-list page 7, and a forum page 8. In turn, these pages 6, 7, 8 may have hyperlinks 12 to item-related Web pages. For example, each invoice quoted in the invoice-status-list page 7 has a hyperlink 13 to an invoice-details page 9 referring to the respective invoice. Likewise, each subject quoted in the forum page 8 has a hyperlink 14 to a message page 10 referring to the respective subject. The upload page 6 has an input field 15 into which participants (e.g. a forwarder 2) can enter a reference (e.g. a file name) to an upload file 11.

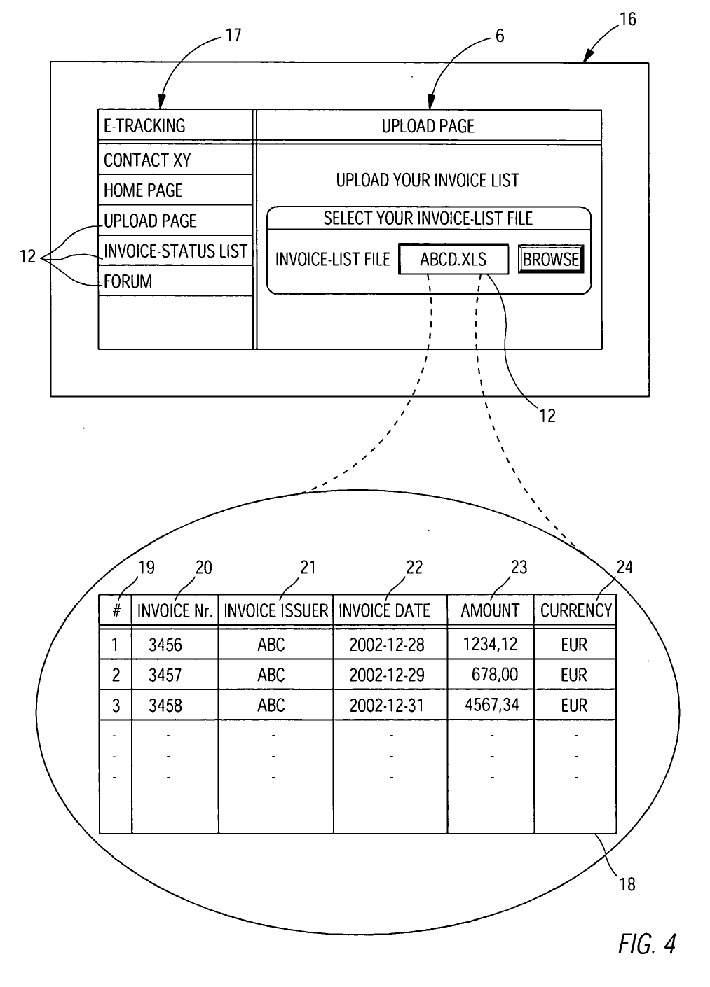

FIG. 4 shows an exemplary upload page 6 within a participant's Web-browser window 16. A navigation bar 17 displays the hyperlinks 12 as well as further hyperlinks, for example a hyperlink to the home page. The upload page 6 includes an invitation to input the file name of an invoice-list file 18 into the input field 12. A browse button 19 is provided to facilitate the searching and inputting of the file name.

An example of an invoice-list file 18 to be uploaded is also shown in FIG. 4. It may, for example, be an Excel table. The table may include attributes, such as a position number 19, an invoice number 20, the name of the issuer 21, the invoice date 22, the invoice amount 23, and the currency 24. Each line (or “invoice item”) 25 corresponds to an invoice which has been (or will be) submitted by the invoice issuer to the invoice recipient. Of course, the invoice-list file 18 may have only a single invoice item 25. In other embodiments, the invoice items 25 can be directly input, line by line, into the upload page 6.

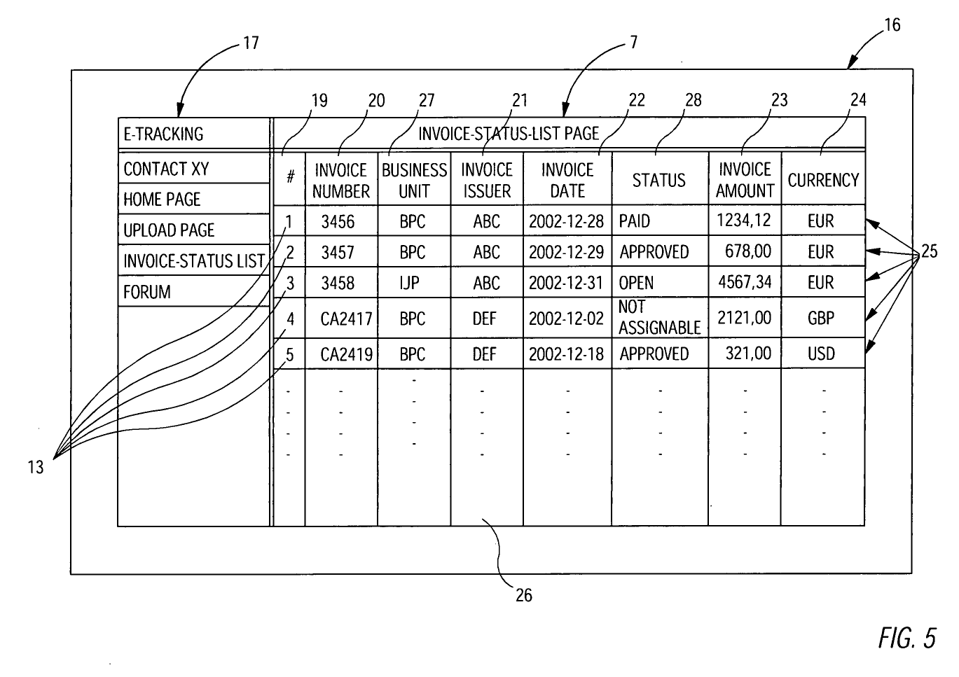

FIG. 5 shows an exemplary invoice-status-list page 7 within a participant's Web browser window 16. The page 7 displays an invoice-status list 26. Some of the list's attributes correspond to the attributes of the uploaded invoice-list 18, such as the attributes 20 to 24. The data contained in the attribute fields of the individual invoice items 25 correspond to the data in the corresponding attribute fields of the uploaded invoice-list 18 (these data may either have been directly taken from the invoice-list file 18, or from an internal invoice database, on the basis of the association of the invoice items in the invoice-list 18 with invoices stored in this database found at R1). The invoice-status list 26 has additional attributes, such as a business-unit attribute 27 and a status attribute 28. Further attributes may pertain to the invoice type, the invoice receipt date, the number of items on an invoice, a due date, an activity month, weight-related information, a credit-debit date, a booking date, a payment date, a voucher number, an approval name, etc. In some embodiments, there are two invoice-receipt-date attributes in order to cope with cases in which a debit note has been submitted twice.

The invoice-status list 26 may be a collection of invoice items 25 from several uploaded invoice-lists 18, including invoice-lists 18 from different invoice issuers 2. For example, the exemplary invoice-status list 26 shown in FIG. 5 includes invoice items 25 from two different invoice issuers 2. Such a list 26 as shown in FIG. 5 will generally only be visible to participants within the invoice recipient's company, for example, an FCM user or a logistics user. However, if the invoice-status-list page 7 is downloaded by an invoice issuer 2, only invoice items 25 pertaining to this invoice issuer 2 will be displayed.

Hyperlinks point to an invoice-details-page 9 for each single invoice item 25, as illustrated in FIG. 3. The invoice-details pages 9 contain more detailed information for each invoice. Depending on what is already displayed in a particular embodiment of the invoice-status list 26, the invoice-details pages 9 may include information about the business unit, the invoice date, the invoice type, one or more receipt dates, the invoice number, the number of items on the invoice, a due date, an activity month, the global status, the payment status, the total amount, the VAT amount, a credit/debit date, a booking date, a payment date, a voucher number, an approval name, etc.

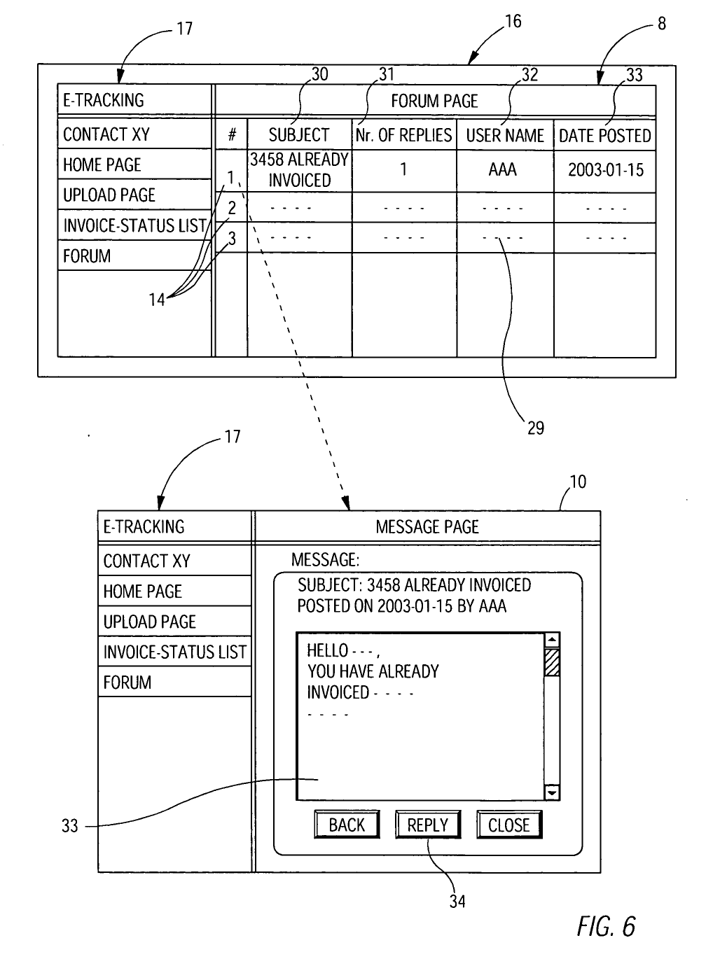

FIG. 6 shows an exemplary forum page 8 within a participant's Web-browser window 16 (with a navigation bar 17, as in FIGS. 4 and 5). The forum page 8 includes a message list 29 with attributes, such as a subject attribute 30, a number-of-replies attribute 31, a user-name attribute and a date-posted attribute 33. Each line of the message list 29 represents a message and, optionally, one or more replies to it. Each line has a hyperlink 14 pointing to the respective message page 10, one of which is also shown in FIG. 6. The message page 10 has a message field 33. In the example shown in FIG. 6, a message text has already been entered into the message field 33. The message page 10 also has a reply button 34 enabling a participant to post a reply to the message in a simple manner. Members of the invoice recipient (such as the SCM department 3 and the logistic department 4) may access all messages, whereas an invoice issuer (such as a forwarder 2) has only access to messages pertaining to invoices issued by him. In some of the embodiments, messages are (only or additionally) linked to individual invoice-list-items 25, either directly from the invoice-status-list page 16 or from invoice-details pages 9.

FIG. 7 shows a high-level functional architecture diagram of an exemplary Web-server computer system 35 coupled to the participant's Web browsers 18 (Web-browser 18-2 of invoice issuer 2 and Web browsers 18-3 and 18-4 of the invoice recipient's departments, for example FCM and logistics departments) via the Internet 36 or the invoice recipient's intranet. The Web-server computer system 35 includes a Web server 37 through which it is coupled to the Internet/intranet 36. The Web server 37 receives HTTP requests from the participants' Web browsers 18 and returns HTTP responses in the form of documents (Web pages) which can be loaded, processed and displayed in the participants' Web browsers 18. On the other hand, the Web server 37 interacts with an application logic 38 and a Web-interface database 39 through a firewall gateway 40. The Web server 37 does not store invoice-related data; it rather forwards request and uploads to the application logic 38 which returns data to be inserted into the Web pages prepared and forwarded by the Web server 37 to the participants 18. Accordingly, the Web server 37 can be considered as a part of an upload and Web-page-forwarding component.

The application logic 38 comprises an interaction manager 41, a user identification and authentication component 42, a session manager 43, a Web-page preparation component 44, an invoice-list uploader 45, an invoice correlation component 46, an invoice-status-change component 47, a forum handler 48. The interaction manager 41 manages the interaction between the application logic 38 and the Web server 37. The user identification and authentication component 42 identifies and authenticates the current participant and provides access-authorization information to other components of the application logic 38 and to the Web server 37. The session manager 43 recognizes requests/responses which together form an invoice-tracking session and binds them together to a secure session, e.g. an SSL connection. The Web-page preparation component 44 prepares and forwards data from the Web-interface database 39 to be inserted in Web pages by the Web server 37. The invoice-list-loading component 45 receives invoice-list data and other data from the Web server 37 and stores them in the Web-interface database 39. The invoice correlation component 46 correlates invoices quoted in uploaded invoice lists with the actual invoices received by the invoice recipient, e.g. paper invoices or electronic invoices; the actual invoices are stored outside the Web-server computer system 35 in a separate invoice database 51. Invoice-related status information is also stored in the separate invoice database 51. When an invoice quoted in an uploaded invoice-list 18 has successfully been correlated with an actual invoice stored in the invoice database 51, the status data (and, optionally, further invoice-related data) is copied from the invoice database 51 to the Web-interface database 39 by the status-change component 47. The status-change component 47 also updates the status data stored in the Web-interface database 39, as soon as a status change appears in the invoice database 51. The forum handler 48 manages the above-described forum functionality of the Web interface; e.g. it stores messages submitted by participants in the Web-interface database 39, and recalls and deletes such messages.

The application logic 38 has two internal interfaces, a parameter interface 49 to the invoice database 51, and an invoice-data interface 50 to a finance service system 52, such as an SAP application. Invoices submitted to the invoice recipient are entered into the invoice database 51. Status changes of invoices stated in the invoice database 51 are entered into the invoice database 51 by a department responsible for invoice processing (e.g. the FCM department using an FCM transactional system 53) or the finance service system 52; manipulation of invoice status through the application logic 38, for example via the interfaces 49 or 50, is not permitted for security reasons. Information about invoices stored in the invoice database 51 is forwarded to the Web server computer-system 35 via the finance service system 52 and the invoice-data interface 50 upon request from the invoice correlation component 46 which, in turn stores the invoice data in the Web-interface database 39. If the status of an invoice is changed in the invoice database 51, a corresponding status update in the data stored in the Web-interface database 39 is automatically triggered by a status-change message via the finance service system 52 and the invoice-data interface 50 to the status-change component 47, which performs the status update in the Web-interface database 39. For security reasons, the parameter interface 49 is only enabled to exchange parameter information (e.g. information not related to individual invoices, such as currency exchange rates, shipping tariffs, etc.), and the invoice-data interface 50 is a one-way interface which does not permit data in the finance service system 52 and the components beyond it to be set or modified. In other embodiments, the invoice-data interface is directly coupled to the invoice database 51. The Web-server computer system 35 and the Web interface 1 hosted by it form a separate layer which, apart from the security-restricted data transfer mentioned above, is independent of the FCM transactional system 53, the invoice database 51 and the finance service system 52.

The Web-server computer system 35 can be implemented using standard Web server hardware and software and standard databases. The digital program code representing the software part of the Web-server computer system 35 may be stored in the main memory and in other dynamic or static memories, such as machine-readable magnetic or optical storage media.

With the embodiments, all participants of an invoice-payment process will be able to track the invoice processing in an improved manner. As a consequence, the embodiments enable invoice processing to be carried out with improved efficiency.

All publications and existing systems mentioned in this specification are herein incorporated by reference.

Although certain methods and products constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

1. A method of enabling an invoice issuer to track, via a Web interface, a processing status of invoices issued to and processed by an invoice recipient, comprising:
enabling the invoice issuer to upload an invoice list with list items referring to invoices issued to the invoice recipient;
correlating the list items with invoices received from the invoice issuer;
putting invoice-status data including information identifying invoices referred to in the invoice list and information about their current processing status into the Web interface, said invoice-status data being accessible by the invoice issuer via the Web interface.

2. The method of claim 1, further comprising:
putting message information into the Web interface, said information being related to the invoice issuer or to individual list items of the invoice list; and
granting the invoice issuer at least read-access to the message information in the Web interface.

3. The method of claim 2, further comprising:
enabling also the invoice issuer to put message information into the Web interface.

4. The method of claim 1, further comprising:
processing invoices received from the invoice issuer and correlated with invoice list items, wherein said processing may result in status changes of the invoices;
updating the information about the current processing status in the invoice-status data in the Web interface.

5. The method of claim 1, wherein status values appearing during the processing comprise representations of an open status, an approved status, and a paid status.

6. The method of claim 1, wherein the Web interface is also used for invoice-related information transfer between different departments of the invoice recipient.

7. The method of claim 1, wherein the method is carried out by the invoice recipient in the framework of freight-cost management of the invoice recipient, and the invoice issuer is a forwarder furnishing forwarding services to the invoice recipient.

8. A server computer system arranged to provide a Web interface enabling an invoice issuer to track a processing status of invoices issued to and processed by an invoice recipient;
the Web interface is arranged to enable the invoice issuer to upload an invoice list with list items referring to invoices issued to the invoice recipient;
the computer system is arranged to correlate the list items with invoices received from the invoice issuer and to put invoice-status data including information putting invoice-status data including information identifying invoices referred to in the invoice list and information about their current processing status into the Web interface;
the Web interface is arranged to grant the invoice issuer access to invoice-status data upon request.

9. A server computer system for enabling an invoice issuer to track a processing status of invoices issued to and processed by an invoice recipient a Web interface, comprising:
a data base arranged to store invoice-related data;
an invoice-list-upload component;
an invoice-correlation component;
a Web-page-preparation component arranged to include stored invoice-related data in Web pages;
a Web-page-forward component.

10. A computer program product including program code, when executed on a computer system, for providing a Web interface enabling an invoice issuer to track a processing status of invoices issued to and processed by an invoice recipient, the program code being arranged to:
enable the invoice issuer to upload an invoice list with list items referring to invoices issued to the invoice recipient;
correlate the list items with invoices received from the invoice issuer;
put invoice-status data including information identifying invoices referred to in the invoice list and information about their current processing status into the Web interface;
grant the invoice issuer access to invoice-status data upon request.

11. A Web interface for enabling an invoice issuer to track a processing status of invoices issued to and processed by an invoice recipient;
the Web interface is arranged to enable the invoice issuer to upload an invoice list with list items referring to invoices issued to the invoice recipient;
the Web interface is arranged to present invoice-status data including information identifying invoices referred to in the invoice list and information about their current processing status;
the Web interface is arranged to grant the invoice issuer access to invoice-status data upon request.

12. An assembly of Web pages representing a Web interface for enabling an invoice issuer to track a processing status of invoices issued to and processed by an invoice recipient;
the Web pages are arranged such that the invoice issuer is able to upload an invoice list with list items referring to invoices issued to the invoice recipient;
the Web pages are arranged such that invoice-status data are presented to the invoice issuer upon request, said invoice-status data including information identifying invoices referred to in the invoice list and information about their current processing status.
